(19) United States
(12) Patent Application Publication
(10) Pub. No.: US 2025/0286569 A1
(43) Pub. Date: Sep. 11, 2025

(54) SYSTEM, METHOD AND COMPUTER PROGRAM FOR DYNAMIC CLOSED-LOOP INTERFERENCE MITIGATION

(71) Applicant: RAKUTEN MOBILE, INC., Tokyo (JP)

(72) Inventor: Krishnan VENKATARAGHAVAN, Tokyo (JP)

(73) Assignee: RAKUTEN MOBILE, INC., Tokyo (JP)

(21) Appl. No.: 18/013,086

(22) PCT Filed: Nov. 30, 2022
(86) PCT No.: PCT/US2022/051339

§ 371 Date: Dec. 27, 2022

(51) Int. Cl. H04B 1/10; H04B 7/185; H04W 52/06; H04W 72/541

(52) U.S. Cl. CPC H04B 1/1027; H04B 7/18519; H04W 52/06; H04W 72/541

(57) ABSTRACT

A method of mitigating interference in a 5^{th} generation (5G) new radio (NR) environment includes determining a cumulative interference level margin corresponding to at least one satellite ground station and at least one base station, determining whether the cumulative interference level margin is less than or equal to a maximum allowed interference margin for the at least one satellite ground station, based on determining that the cumulative interference level margin is less than or equal to the maximum allowed interference margin, determining at least one of an optimal equivalent isotopically radiated power (EIRP) for the at least one base station and an optimal tilt for the at least one base station, and configuring the at least one base station based on at least one of the optimal EIRP and the optimal tilt configuration.

### BACKGROUND

### 1. Field

Apparatuses and methods consistent with example embodiments of the present disclosure relate to mitigating interference in a 5^{th} generation (5G) new radio (NR) environment.

### 2. Description of Related Art

As mobile operators continue to rollout 5^{th} generation (5G) cell sites in both the sub6 and mmWave deployment modes, there is an increasing impact of interference on the C-Band satellite ground stations which receive signals in the frequency range from 3.4 Ghz to 4.2 Ghz. Amongst the deployment options of 5G new radio (NR), the interference is caused by the sub6 operating ranges (e.g., 3.3 Ghz to 3.6 Ghz) since the range essentially overlaps with the C-Band operating range of satellite ground stations.

Mitigating interference is especially critical because the satellite ground stations are designed to receive the signals at very weak signal levels considering the possible signal distortions between the space hosting the satellite transmitter and the ground base stations hosting the receivers which operate in the C-Band. Furthermore, it is expected that the NR mobile tower radiated power would be several orders of magnitude higher than a power at which satellite base station receives the signals. Thus, there is extremely high scale of interference at the satellite base station receivers which causes harmful impacts, such as satellite receiver entering lock failure states with respect to the transmitter, signal saturations such as signal degradations including inter-modulations, phase distortions, etc.

Related art implementations of C-Band interference mitigation follow a suboptimal approach by where, upon determining the target interference levels to be met at the satellite base station for each newly integrated 5G NR site, a model may be provided with inputs such as the lowest, default static power and planned antenna tilts (e.g., per sector). Based on a determination of the cumulative interference being lower than admissible level, the power and tilt configurations are considered optimal configurations for the on-air configurations. Based on a determination of the cumulative interference level not meeting the required criterion, the newly integrated sites are considered as a candidate which cannot be made on-air. This results in both suboptimal footprints, loss of revenue as well as poor customer perception for users of the 5G network.

Furthermore, the methodology of interference assessment in the related art does not perform a dynamic closed-loop assessment with the underlying configuration aspects of 5G deployment. This causes unwanted interference on the satellite ground stations that operate in the C-Band, thereby resulting in unwanted outcomes such as gain compression, lock failures, saturation, noise floor degradation, intermodulation, etc.

Hence, there is a need to enhance the overall C-band interference mitigation and improve not only the number of 5G base stations getting on-air but also ensure that the 5G base stations go on-air with the most optimal configurations, to ensure the best customer satisfaction, operator revenue as well enhanced footprints.

### SUMMARY

According to embodiments, systems and methods are provided for mitigating interference in a 5^{th} generation (5G) new radio (NR) environment in the C-Band.

According to an aspect of the disclosure, a method of mitigating interference in a 5G NR environment may include determining a cumulative interference level margin corresponding to at least one satellite ground station and at least one base station, determining whether the cumulative interference level margin is less than or equal to a maximum allowed interference margin for the at least one satellite ground station, based on determining that the cumulative interference level margin is less than or equal to the maximum allowed interference margin, determining at least one of an optimal equivalent isotopically radiated power (EIRP) for the at least one base station and an optimal tilt for the at least one base station, and configuring the at least one base station based on at least one of the optimal EIRP and the optimal tilt configuration.

According to an aspect of the disclosure, a system for mitigating interference in a 5G NR environment may include at least one memory storing instructions and at least one processor configured to execute the instructions to determine a cumulative interference level margin corresponding to at least one satellite ground station and at least one base station, determine whether the cumulative interference level margin is less than or equal to a maximum allowed interference margin for the at least one satellite ground station, based on determining that the cumulative interference level margin is less than or equal to the maximum allowed interference margin, determine at least one of an optimal EIRP for the at least one base station, and an optimal tilt for the at least one base station, and configure the at least one base station based on at least one of the optimal EIRP and the optimal tilt configuration.

According to an aspect of the disclosure, a non-transitory computer-readable storage medium may store instructions that, when executed by at least one processor, cause the at least one processor to determine a cumulative interference level margin corresponding to at least one satellite ground station and at least one base station, determine whether the cumulative interference level margin is less than or equal to a maximum allowed interference margin for the at least one satellite ground station, based on determining that the cumulative interference level margin is less than or equal to the maximum allowed interference margin, determine at least one of an optimal EIRP for the at least one base station, and an optimal tilt for the at least one base station, and configure the at least one base station based on at least one of the optimal EIRP and the optimal tilt configuration.

Additional aspects will be set forth in part in the description that follows and, in part, will be apparent from the description, or may be realized by practice of the presented embodiments of the disclosure.

### BRIEF DESCRIPTION OF THE DRAWINGS

Features, advantages, and significance of exemplary embodiments of the disclosure will be described below with reference to the accompanying drawings, in which like signs denote like elements, and where:

FIG. 1 is a diagram of a 5^{th} generation (5G) new radio (NR) environment, according to an embodiment;

FIGS. 2 and 3 are tables of inventory databases, according to an embodiment;

FIG. 4 is a flowchart of a method for interference mitigation, according to an embodiment;

FIG. 5 is a flowchart of a method for interference mitigation, according to an embodiment;

FIG. 6 is a diagram of an example environment in which systems and/or methods, described herein, may be implemented, according to an embodiment; and

FIG. 7 is a diagram of example components of a device according to an embodiment.

### DETAILED DESCRIPTION

The following detailed description of example embodiments refers to the accompanying drawings. The same reference numbers in different drawings may identify the same or similar elements.

The foregoing disclosure provides illustration and description, but is not intended to be exhaustive or to limit the implementations to the precise form disclosed. Modifications and variations are possible in light of the above disclosure or may be acquired from practice of the implementations. Further, one or more features or components of one embodiment may be incorporated into or combined with another embodiment (or one or more features of another embodiment). Additionally, in the flowcharts and descriptions of operations provided below, it is understood that one or more operations may be omitted, one or more operations may be added, one or more operations may be performed simultaneously (at least in part), and the order of one or more operations may be switched.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code. It is understood that software and hardware may be designed to implement the systems and/or methods based on the description herein.

Even though particular combinations of features are recited in the claims and/or disclosed in the specification, these combinations are not intended to limit the disclosure of possible implementations. In fact, many of these features may be combined in ways not specifically recited in the claims and/or disclosed in the specification. Although each dependent claim listed below may directly depend on only one claim, the disclosure of possible implementations includes each dependent claim in combination with every other claim in the claim set.

No element, act, or instruction used herein should be construed as critical or essential unless explicitly described as such. Also, as used herein, the articles “a” and “an” are intended to include one or more items, and may be used interchangeably with “one or more.” Where only one item is intended, the term “one” or similar language is used. Also, as used herein, the terms “has,” “have,” “having,” “include,” “including,” or the like are intended to be open-ended terms. Further, the phrase “based on” is intended to mean “based, at least in part, on” unless explicitly stated otherwise. Furthermore, expressions such as “at least one of [A] and [B]” or “at least one of [A] or [B]” are to be understood as including only A, only B, or both A and B.

Provided are systems, methods and devices for mitigating interference in a 5G NR environment. The system may determine a cumulative interference level margin corresponding to at least one satellite ground station and at least one base station, determine whether the cumulative interference level margin is less than or equal to a maximum allowed interference margin for the at least one satellite ground station, based on determining that the cumulative interference level margin is less than or equal to the maximum allowed interference margin, determine an optimal equivalent isotopically radiated power (EIRP) for the at least one base station and/or an optimal tilt for the at least one base station, and configure the at least one base station based on at least one of the optimal EIRP and the optimal tilt configuration.

Provided are systems, methods and devices that dynamically assess the interference levels contributed by each deployed 5^{th} generation (5G) new radio (NR)-mmWave/sub6 base station within a network environment, and perform dynamic loop-closing of underlying configuration aspects to ensure the interference levels at the satellite ground station(s) (e.g., Earth stations) are kept within an allowed/preconfigured operating range.

Thus, the provided systems, methods and devices may to estimate the most optimal configuration of both the EIRP and the tilt configurations (e.g., electrical or magnetic (E/M) tilt configures) as well increase the effective number of 5G NR base stations which can be transmitted without breaching the interference margins defined by standards, regulatory bodies, or other predetermined configurations for the network.

The systems, methods and devices may implement a prediction model, such as the model defined by the international telecommunications union (ITU) P.452-16. ITU P.452-16 defines a prediction method to determine the interference levels between any two transmitters on the Earth operating in the frequency range between 0.1 and 50 Ghz. Table 1 shows basic inputs need for the model to produce the prediction of a cumulative total interference on an interference target (IT).

TABLE 1
Basic input data

| | Preferred | |
|---|---|---|
| Parameter | resolution | Description |
| f | 0.01 | Frequency (GHz) |
| p | 0.001 | Required time percentage(s) for which the |
| | | calculated basic transmission loss is not exceeded |
| φ [symbol] , φ [symbol] | 0.001 | Latitude of station (degrees) |
| ψ [symbol] , ψ [symbol] | 0.001 | Longitude of station (degrees) |
| h [symbol] , h [symbol] | 1 | Antenna centre height above ground level (m) |
| h [symbol] , h [symbol] | 1 | Antenna centre height above mean sea level (m) |
| G [symbol] , G [symbol] | 0.1 | Antenna gain in the direction of the horizon along |
| | | the great-circle interference path (dBi) |
| Pol | N/A | Signal, e.g. vertical or horizontal |

NOTE 1
For the interfering and interfered-with stations: [symbol]
: interferer [symbol]
: interfered-with station. [symbol]
indicates data missing or illegible when filed

The model considers propagation mechanisms such as line of sight, diffraction, tropospheric scatter (e.g., droplets of rain causing the signal to change path), surface ducting (an atmospheric phenomenon where there is clear line of sight (signal transmitted without diffraction), but where there is a layer of dust, mist, fog, etc. causing the signal to change trajectory), etc. The model also considers propagation losses for each clutter class considering the climatic aspects, time of the month, etc., from the meteorological data to estimate the worst and best months in a particular region with respect to the clutter losses, spherical earth diffraction losses, etc. The model further factors in the absolute transmit power, gain the relative angle of arrival, distance of separation between the source and transit antenna with the above factors (e.g., determining the transmission losses) to arrive at the average cumulative interference at the receiver (e.g., the IT) by one/group of transmitters (e.g., the interference source (IS)). Further details may be found in ITU P.452-16, the contents of which are incorporated herein by reference.

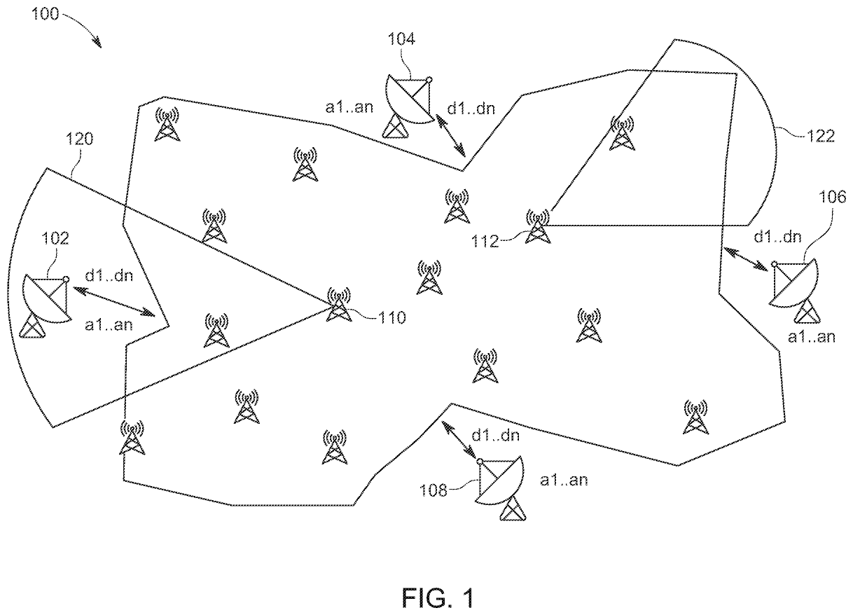

FIG. 1 is a diagram of a 5G NR environment 100, according to an embodiment. The 5G NR environment 100 may include a plurality of satellite ground stations (e.g., Earth stations), such as satellite ground stations 102, 104, 106 and 108. Furthermore, the 5G NR environment 100 may include a plurality of base stations, such as base stations 110 and 112. Each base station, when active, may be configured to produce a sector corresponding to its respective coverage area. For example, base station 110 may be configured to produce sector 120 corresponding to the coverage area of the base station 110, and base station 112 may be configured to produce sector 122 corresponding to the coverage area of the base station 112. The sector 120 of base station 110 includes the satellite ground station 102, whereas the sector 122 of base station 112 does not include any satellite ground station.

Various values are described herein. For example, the min/max EIRP (dbm) may represent the minimum and maximum allowed transmit power for the 5G base station as part of the interference determination. The min/max E/M tilt may represent the minimum and maximum E/M tilt (in degrees) for the 5G base station as part of the interference determination. EIRP step size may represent the predetermined step size of range of possible values for EIRP changes (e.g., 30 dbm, 45 dbm, 50 dbm, 75 dbm, etc.). The E/M tilt step size may represent a predetermined step size for E/M tilt changes. A sector priority may refer to a priority of 5G deployment. The sector priority may include a critical priority and a non-critical priority, and the type of priority may be determined based on various factors, such as population density, hotspot area, VIP area, railway coverage, etc. An allowed interference margin may represent the allowed headroom between the maximum allowed interference margin at the satellite ground station and a calculated cumulative interference. An allowed NR-reference signal received power (RSRP)/NR-signal to interference and noise ratio (SINR) margin may represent the allowed deviation in NR-RSRP/NR-SINR per coverage policy (e.g., per sector).

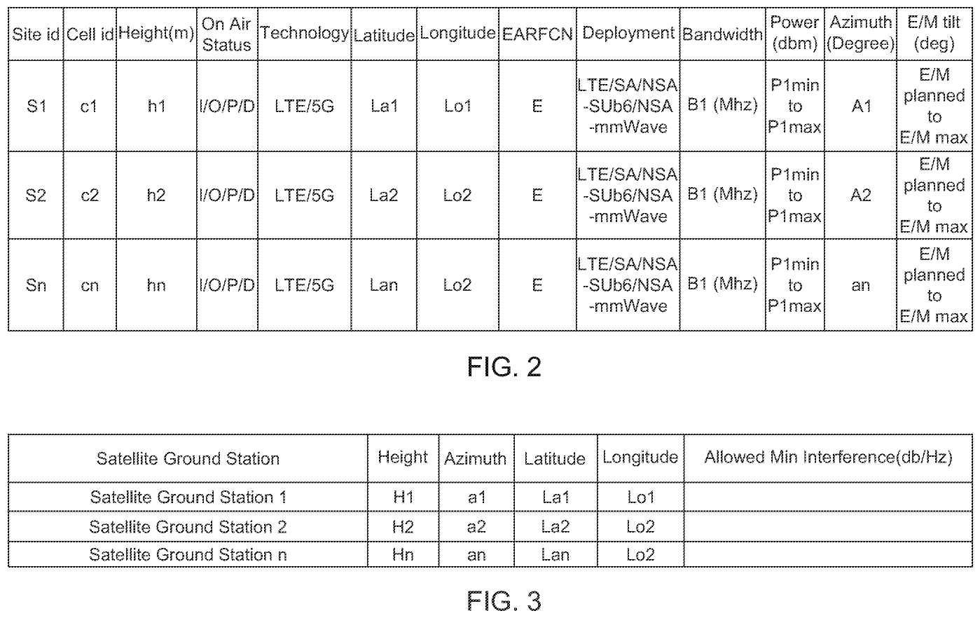

FIGS. 2 and 3 are tables of inventory databases, according to an embodiment. A maximum allowed cumulative interference at a satellite ground station may be determined based on the information in the inventory databases. As shown in FIGS. 2 and 3, the inventory database includes details of all 5G/long term evolution (LTE) base stations (e.g., ISs), including the site id, cell id, physical coordinates, latitude and longitude, azimuth, the average height above mean sea level (of the deployed antenna), transmit power (dbm), antenna gains (db), evolved universal terrestrial access (E-UTRA) absolute radio frequency channel number (EARFCN), bandwidth, technology (e.g., LTE/5G) and deployment type, antenna beamwidth of operation, etc.

As shown in FIG. 3, the inventory databases may also include satellite ground station (e.g., ITs) details, such as mean sea level, height, azimuth, coordinates (latitude and longitude) and a maximum cumulative interference per satellite ground station.

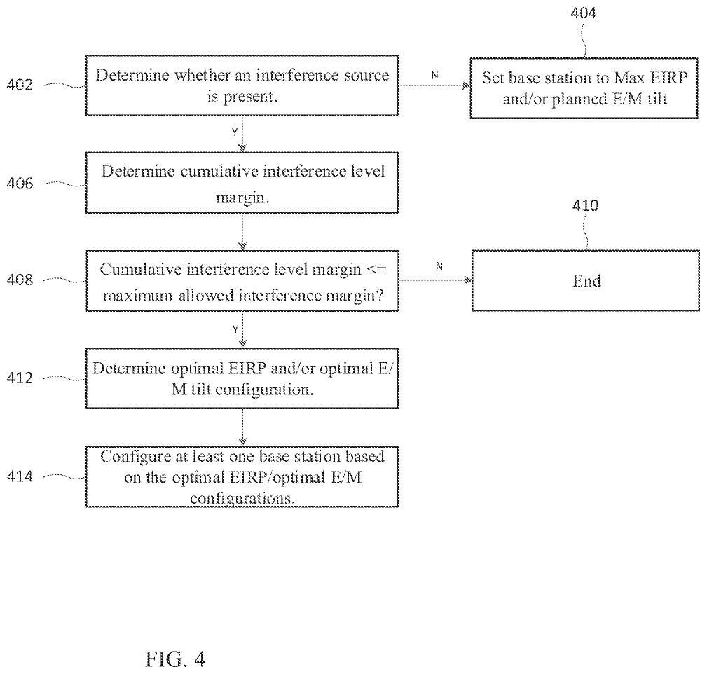

FIG. 4 is a flowchart of a method for interference mitigation, according to an embodiment. In operation 402, the system may determine whether an IS is present. The system may identify a base station and then determine a sector produced by the base station. When at least one satellite ground station is present within the sector, the system may determine that an IS is present. In some embodiments, when at least one satellite ground station is present with an arc radius corresponding to a sector beamwidth (i.e., a horizontal area of coverage of the sector when the sector is active) and a distance of separation between an IS and an IT, the system may determine that an IS is present. The IS may refer to the interference source, such as a 5G base station, and the IT may refer to an interference target, such as a satellite ground station. The distance of separation between the IS and the IT may be determined based on their coordinates using line equations. For example, the distance of separation may be determined as in Equation (1)

$$sqrt [ ( IS latitude - IT latitude ) / ( IS longitude - IT longitude ) ] \qquad ( 1 )$$

For each coordinate within the arc radius, a potential number of IS's may be determined. For example, if the number of coordinates corresponding to a satellite ground station in the arc are greater than or equal to 1, the system may mark the corresponding sectors as potential IS's, while marking other sectors as not potentially including IS's. When no satellite ground station is present within the sector (or within an arc radius corresponding to a sector beamwidth and a distance of separation between an IS and an IT), the system may determine that no IS is present. For example, referring to FIG. 1, as the sector 120 produced by the base station 110 includes the satellite ground station 102, the system may identify that the sector 120 includes a potential IS. Alternatively, as the sector 122 produced by the base station 110 does not include any satellite ground station, the system may determine that sector 122 does not include a potential IS. The system may require a predetermined number of potential ISs (e.g., 1, 2, etc.) to be detected in order to determine whether an IS is present (e.g., in some embodiments, the system is required to detect more than 1 potential IS).

In operation 404, when the system determines that no IS is present, the system may set the base station to a maximum EIRP and/or a predetermined E/M tilt.

In operation 406, when the system determines that an IS is present, the system may determine a cumulative interference level margin. Furthermore, the system may set the EIRP of base stations producing sectors with ISs to a minimum value and set the E/M tilt of such base stations to a predetermined E/M tilt. To determine the cumulative interference level margin, the system may implement the model described in ITU P.452-16 using various inputs, such as a distance of separation from an IS to IT, a cumulative interference at the IT, the IS candidate status, a transmit power, E/M tilt, and azimuth of the IS, etc. The cumulative interference level margin may represent a difference between an allowed maximum interference margin for the at least one satellite ground station and a cumulative interference of at least one base station.

In operation 408, the system may determine whether the cumulative interference level margin is less than or equal to the maximum allowed interference margin. When the cumulative interference level margin is not less than or equal to the maximum allowed interference margin, then in operation 410, the method may end. That is, a maximum allowed interference is already exceeded, and therefore, no further adjustments may be made.

In operation 412, when the cumulative interference level margin is less than or equal to the maximum allowed interference margin, the system may determine an optimal EIRP and/or an optimal E/M tilt configuration for a base station producing a sector having an IS. Operation 412 includes various sub-operations that will be described in detail below when respect to an embodiment where one base station includes one sector having one IS (e.g., one satellite ground station), but the embodiments disclosed herein are not limited as such.

In a first overall operation, the system may determine EIRP adjustments for critical priority base stations/sectors. First, the system may determine a sector priority status. That is, the system may determine whether the sector is of critical priority or is of non-critical priority. When the sector is of critical priority, the system may obtain a currently configured EIRP of the base station producing the sector. If the currently configured EIRP is less than or equal to a maximum EIRP, the system may obtain a difference between the currently configured EIRP and the maximum EIRP. In examples where the difference is 0, the system may set a flag indicating that an EIRP change for the sector is not allowed (or at least not preferred). Otherwise, the system may reconfigure the current EIRP of the base station by incrementing the EIRP by a predetermined EIRP step value. Then, the system may obtain a cumulative interference level margin based on the newly incremented EIRP. If the difference between the maximum allowed interference margin and a generated cumulative interference level margin based on EIRP adjustments is less than or equal to 0 (i.e., the cumulative interference level margin is less than the maximum allowed interference margin), the system may repeat this process for other base stations/sectors with a critical priority. If the difference between the maximum allowed interference margin and a generated cumulative interference level margin based on tilt adjustments is greater than to 0, then the maximum allowed interference margin is exceeded, and the system may proceed to a second overall operation described below.

In examples involving multiple base stations/sectors, the first overall operation may be repeated for each critical base station. Furthermore, the system may implement a priority ranking for the base stations. For example, the system may rank priority of the base stations based on the difference between the currently configured EIRP and the maximum EIRP. For example, a first base station may have a difference of 40 dbm, while a second base station may have a difference of 20 dbm. That is, the first base station may have more available power than the second base station. Thus, the system may prioritize the first base station for EIRP adjustments, and then consider the second base station when the first overall operation is repeated.

If the difference between the maximum allowed interference margin and a generated cumulative interference level margin based on tilt adjustments is greater than to 0, then the maximum allowed interference margin is exceeded, and the system may proceed to a second overall operation described below, where the system may determine E/M tilt configurations for non-critical base stations/sectors.

In the second overall operation, the system may first obtain a current E/M tilt of the base station where an E/M tilt change is allowed (i.e., some base stations/sectors may include a flag indicating that a tilt change is not allowed). The system may set a flag on the base station indicating that a change in tilt is not allowed if the system determines that the current E/M tilt is equal to the maximum E/M tilt for the base station. The system may obtain a difference between a maximum E/M tilt and the current E/M tilt of the base station. The system may increase the E/M tilt of the base station by a predetermined tilt step when the current E/M tilt is less than the maximum E/M tilt. Then, the system may obtain an NR-RSRP and/or and NR-SINR corresponding to the base station. If the NR-RSRP/NR-SINR is less than an allowed NR-RSRP/NR-SINR margin, then the increase may be confirmed (e.g., the system may update the new E/M tilt for the base station), and the system may again determine whether the new changes result in an excess of the maximum allowed interference margin. If the NR-RSRP/NR-SINR is greater than or equal to the allowed NR-RSRP/NR-SINR margin, the system may revert the previously performed increase in the E/M tilt, set a flag indicating that tilt changes are not allowed for the base station, and then repeat the second overall operation for subsequent base stations, if required. If the difference between the maximum allowed interference margin and a generated cumulative interference level margin based on tilt adjustments is less than or equal to 0 (i.e., the cumulative interference level margin is less than the maximum allowed interference margin), the system may repeat this process for other base stations/sectors with a non-critical priority. If the difference between the maximum allowed interference margin and a generated cumulative interference level margin based on tilt adjustments is greater than to 0, then the maximum allowed interference margin is exceeded, and the system may proceed to a third overall operation.

Similar to the first overall operation, in embodiments where multiple base stations/sectors are present, the second overall operation may be repeated for each non-critical base station. Furthermore, the system may implement a priority ranking for the base stations. For example, the system may rank priority of the base stations based on the difference between the current tilt and the maximum allowed tilt. For example, the maximum allowed tilt may be 60 degrees. A first base station may have a current tilt of 30 degrees, while a second base station may have a current tilt of 50 degrees. That is, the first base station may have more available tilting adjustments than the second base station. Thus, the system may prioritize the first base station for tilt adjustments, and then consider the second base station when the second overall operation is repeated.

If no more tilting adjustments may be made, and/or if the difference between the maximum allowed interference margin and a generated cumulative interference level margin based on tilt adjustments is greater than to 0 (i.e., the maximum allowed interference margin is exceeded), the system may proceed to a third overall operation of adjusting tilts of base stations/sectors with critical priority. The process of the third overall operation is substantially similar to the process described with the second overall operation, except that the process is performed on critical base stations, and repeated descriptions will be omitted.

If no more tilting adjustments may be made, and/or if the difference between the maximum allowed interference margin and a generated cumulative interference level margin based on tilt adjustments is greater than 0, the system may proceed to a fourth overall operation of adjusting EIRP of base stations/sectors with non-critical priority. The process of the fourth overall operation is similar to the process described with the first overall operation, and repeated descriptions will be omitted. However, the fourth overall operation differs from the third overall operation in that the system may obtain a currently configured EIRP for a non-critical base station that includes a flag indicating that no tilt change is allowed. Furthermore, the system may set a flag for base stations indicating that an EIRP change is not allowed for sectors where the currently configured EIRP is equal to a predetermined minimum EIRP. Furthermore, as the fourth overall operation concerns non-critical base stations, the EIRP adjustments may be reductions in the EIRP of the base station (i.e., by reducing the EIRP of non-critical base stations, interference may be reduce on the critical base stations). The fourth operation may be repeated until there are no more non-critical base stations with allowed EIRP adjustments and/or the difference between the maximum allowed interference margin and a generated cumulative interference level margin based on the EIRP adjustments of the fourth overall operation is greater than 0.

Then the system may proceed to a fifth overall operation of EIRP adjustment for critical base stations. The fifth overall operation is similar to the fourth overall operation in that the fifth overall operation involves EIRP reductions in critical base stations. The fifth operation may be repeated until there are no more critical base stations with allowed EIRP adjustments and/or when a difference the maximum allowed interference margin and a generated cumulative interference level margin based on the EIRP adjustments of the fifth overall operation is greater than 0. Put alternatively, the fifth overall operation may be correcting for power adjustments made in the first overall operation when a maximum allowed interference margin is still being exceed.

As described with respect to the first through fifth overall operations above, in embodiments involving multiple base states/sectors in each operation, the system may repeat each operation until each base station/sector has been processed, and then, after each base station/sector has been processed, the system may perform the interference check. That is, the system may determine a difference the maximum allowed interference margin and a generated cumulative interference level margin after all respective adjustments are made for the respective operation.

In operation 414, the system may configure at least one base station based on the optimal EIRP and/or optimal E/M configurations determined in operation 412 as described above. The system may configure the at least one base station based on the optimal EIRP adjustments and tilt adjustments determined in operation 412.

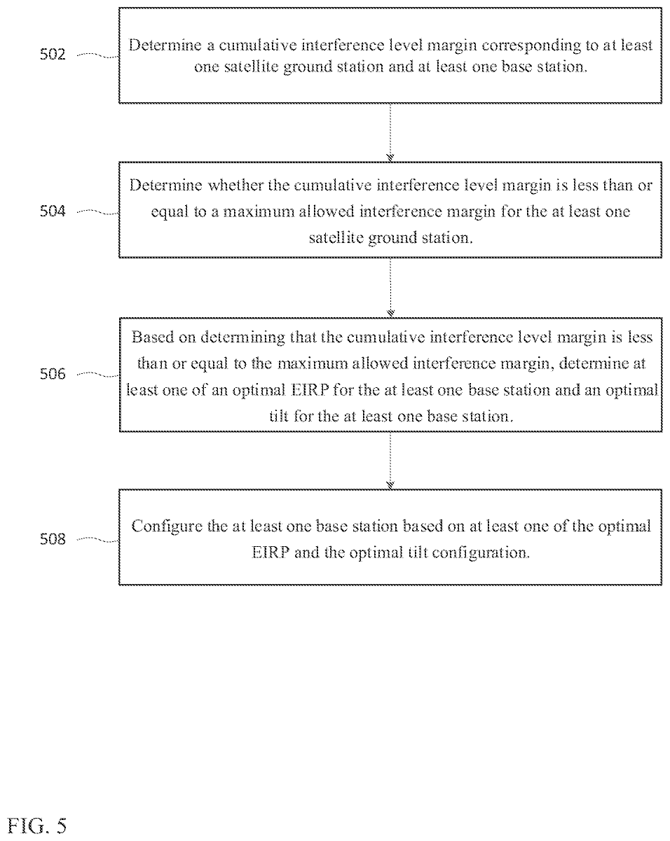

FIG. 5 is a flowchart of a method for interference mitigation, according to an embodiment. In operation 502, the system may determine a cumulative interference level margin corresponding to at least one satellite ground station and at least one base station. In operation 504, the system may determine whether the cumulative interference level margin is less than or equal to a maximum allowed interference margin for the at least one satellite ground station. In operation 506, the system may, based on determining that the cumulative interference level margin is less than or equal to the maximum allowed interference margin, determine at least one of an optimal EIRP for the at least one base station and an optimal tilt for the at least one base station. In operation 508, the system may configure the at least one base station based on at least one of the optimal EIRP and the optimal tilt configuration.

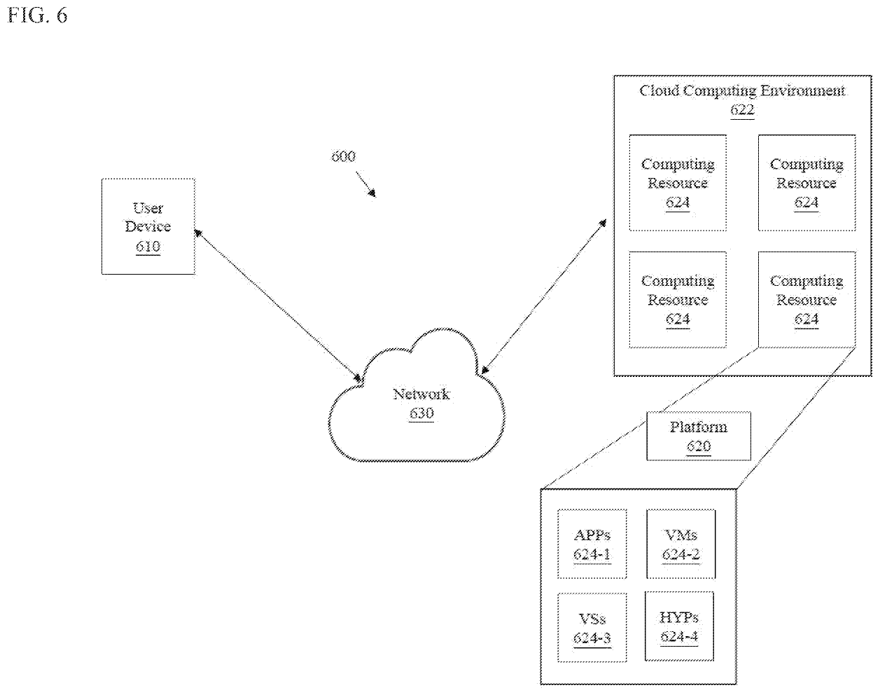

FIG. 6 is a diagram of an example environment 600 in which systems and/or methods, described herein, may be implemented. As shown in FIG. 6, environment 600 may include a user device 610, a platform 620, and a network 630. Devices of environment 600 may interconnect via wired connections, wireless connections, or a combination of wired and wireless connections. In embodiments, any of the functions and operations described with reference to FIG. 6 above may be performed by any combination of elements illustrated in FIG. 6.

User device 610 includes one or more devices capable of receiving, generating, storing, processing, and/or providing information associated with platform 620. For example, user device 610 may include a computing device (e.g., a desktop computer, a laptop computer, a tablet computer, a handheld computer, a smart speaker, a server, etc.), a mobile phone (e.g., a smart phone, a radiotelephone, etc.), a wearable device (e.g., a pair of smart glasses or a smart watch), or a similar device. In some implementations, user device 610 may receive information from and/or transmit information to platform 620.

Platform 620 includes one or more devices capable of receiving, generating, storing, processing, and/or providing information. In some implementations, platform 620 may include a cloud server or a group of cloud servers. In some implementations, platform 620 may be designed to be modular such that certain software components may be swapped in or out depending on a particular need. As such, platform 620 may be easily and/or quickly reconfigured for different uses.

In some implementations, as shown, platform 620 may be hosted in cloud computing environment 622. Notably, while implementations described herein describe platform 620 as being hosted in cloud computing environment 622, in some implementations, platform 620 may not be cloud-based (i.e., may be implemented outside of a cloud computing environment) or may be partially cloud-based.

Cloud computing environment 622 includes an environment that hosts platform 620. Cloud computing environment 622 may provide computation, software, data access, storage, etc. services that do not require end-user (e.g., user device 610) knowledge of a physical location and configuration of system(s) and/or device(s) that hosts platform 620. As shown, cloud computing environment 622 may include a group of computing resources 624 (referred to collectively as “computing resources 624” and individually as “computing resource 624”).

Computing resource 624 includes one or more personal computers, a cluster of computing devices, workstation computers, server devices, or other types of computation and/or communication devices. In some implementations, computing resource 624 may host platform 620. The cloud resources may include compute instances executing in computing resource 624, storage devices provided in computing resource 624, data transfer devices provided by computing resource 624, etc. In some implementations, computing resource 624 may communicate with other computing resources 624 via wired connections, wireless connections, or a combination of wired and wireless connections.

As further shown in FIG. 6, computing resource 624 includes a group of cloud resources, such as one or more applications (“APPs”) 624-1, one or more virtual machines (“VMs”) 624-2, virtualized storage (“VSs”) 624-3, one or more hypervisors (“HYPs”) 624-4, or the like.

Application 624-1 includes one or more software applications that may be provided to or accessed by user device 610. Application 624-1 may eliminate a need to install and execute the software applications on user device 610. For example, application 624-1 may include software associated with platform 620 and/or any other software capable of being provided via cloud computing environment 622. In some implementations, one application 624-1 may send/receive information to/from one or more other applications 624-1, via virtual machine 624-2.

Virtual machine 624-2 includes a software implementation of a machine (e.g., a computer) that executes programs like a physical machine. Virtual machine 624-2 may be either a system virtual machine or a process virtual machine, depending upon use and degree of correspondence to any real machine by virtual machine 624-2. A system virtual machine may provide a complete system platform that supports execution of a complete operating system (“OS”). A process virtual machine may execute a single program, and may support a single process. In some implementations, virtual machine 624-2 may execute on behalf of a user (e.g., user device 610), and may manage infrastructure of cloud computing environment 622, such as data management, synchronization, or long-duration data transfers.

Virtualized storage 624-3 includes one or more storage systems and/or one or more devices that use virtualization techniques within the storage systems or devices of computing resource 624. In some implementations, within the context of a storage system, types of virtualizations may include block virtualization and file virtualization. Block virtualization may refer to abstraction (or separation) of logical storage from physical storage so that the storage system may be accessed without regard to physical storage or heterogeneous structure. The separation may permit administrators of the storage system flexibility in how the administrators manage storage for end users. File virtualization may eliminate dependencies between data accessed at a file level and a location where files are physically stored. This may enable optimization of storage use, server consolidation, and/or performance of non-disruptive file migrations.

Hypervisor 624-4 may provide hardware virtualization techniques that allow multiple operating systems (e.g., “guest operating systems”) to execute concurrently on a host computer, such as computing resource 624. Hypervisor 624-4 may present a virtual operating platform to the guest operating systems, and may manage the execution of the guest operating systems. Multiple instances of a variety of operating systems may share virtualized hardware resources.

Network 630 includes one or more wired and/or wireless networks. For example, network 630 may include a cellular network (e.g., a fifth generation (5G) network, a long-term evolution (LTE) network, a third generation (3G) network, a code division multiple access (CDMA) network, etc.), a public land mobile network (PLMN), a local area network (LAN), a wide area network (WAN), a metropolitan area network (MAN), a telephone network (e.g., the Public Switched Telephone Network (PSTN)), a private network, an ad hoc network, an intranet, the Internet, a fiber optic-based network, or the like, and/or a combination of these or other types of networks

The number and arrangement of devices and networks shown in FIG. 6 are provided as an example. In practice, there may be additional devices and/or networks, fewer devices and/or networks, different devices and/or networks, or differently arranged devices and/or networks than those shown in FIG. 6. Furthermore, two or more devices shown in FIG. 6 may be implemented within a single device, or a single device shown in FIG. 6 may be implemented as multiple, distributed devices. Additionally, or alternatively, a set of devices (e.g., one or more devices) of environment 600 may perform one or more functions described as being performed by another set of devices of environment 600.

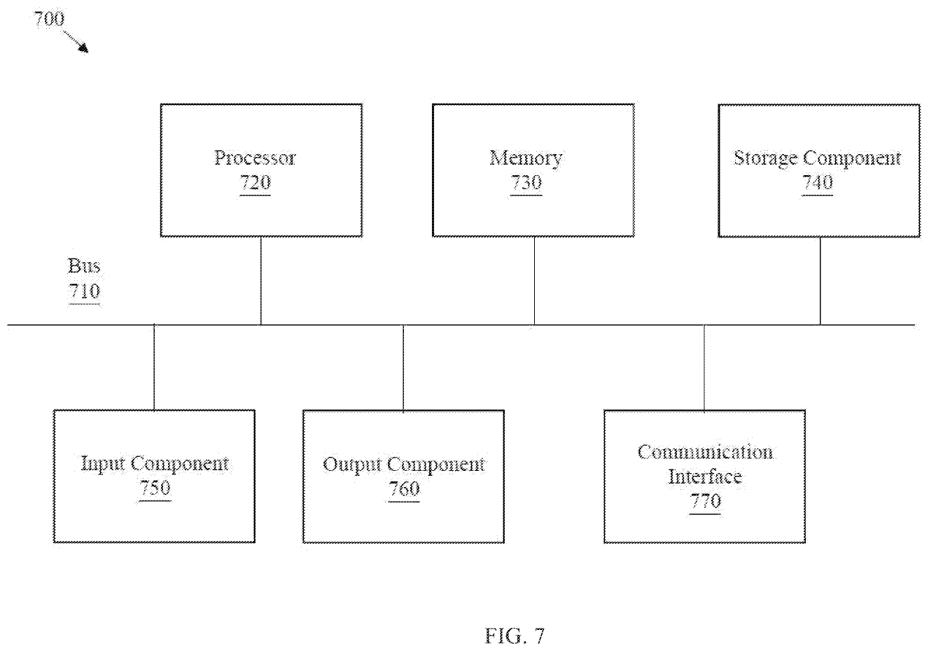

FIG. 7 is a diagram of example components of a device 700. Device 700 may correspond to user device 610 and/or platform 620. As shown in FIG. 7, device 700 may include a bus 710, a processor 720, a memory 730, a storage component 740, an input component 750, an output component 760, and a communication interface 770.

Bus 710 includes a component that permits communication among the components of device 700. Processor 720 may be implemented in hardware, firmware, or a combination of hardware and software. Processor 720 may be a central processing unit (CPU), a graphics processing unit (GPU), an accelerated processing unit (APU), a microprocessor, a microcontroller, a digital signal processor (DSP), a field-programmable gate array (FPGA), an application-specific integrated circuit (ASIC), or another type of processing component. In some implementations, processor 720 includes one or more processors capable of being programmed to perform a function. Memory 730 includes a random access memory (RAM), a read only memory (ROM), and/or another type of dynamic or static storage device (e.g., a flash memory, a magnetic memory, and/or an optical memory) that stores information and/or instructions for use by processor 720.

Storage component 740 stores information and/or software related to the operation and use of device 700. For example, storage component 740 may include a hard disk (e.g., a magnetic disk, an optical disk, a magneto-optic disk, and/or a solid state disk), a compact disc (CD), a digital versatile disc (DVD), a floppy disk, a cartridge, a magnetic tape, and/or another type of non-transitory computer-readable medium, along with a corresponding drive. Input component 750 includes a component that permits device 700 to receive information, such as via user input (e.g., a touch screen display, a keyboard, a keypad, a mouse, a button, a switch, and/or a microphone). Additionally, or alternatively, input component 750 may include a sensor for sensing information (e.g., a global positioning system (GPS) component, an accelerometer, a gyroscope, and/or an actuator). Output component 760 includes a component that provides output information from device 700 (e.g., a display, a speaker, and/or one or more light-emitting diodes (LEDs)).

Communication interface 770 includes a transceiver-like component (e.g., a transceiver and/or a separate receiver and transmitter) that enables device 700 to communicate with other devices, such as via a wired connection, a wireless connection, or a combination of wired and wireless connections. Communication interface 770 may permit device 700 to receive information from another device and/or provide information to another device. For example, communication interface 770 may include an Ethernet interface, an optical interface, a coaxial interface, an infrared interface, a radio frequency (RF) interface, a universal serial bus (USB) interface, a Wi-Fi interface, a cellular network interface, or the like.

Device 700 may perform one or more processes described herein. Device 700 may perform these processes in response to processor 720 executing software instructions stored by a non-transitory computer-readable medium, such as memory 730 and/or storage component 740. A computer-readable medium is defined herein as a non-transitory memory device. A memory device includes memory space within a single physical storage device or memory space spread across multiple physical storage devices.

Software instructions may be read into memory 730 and/or storage component 740 from another computer-readable medium or from another device via communication interface 770. When executed, software instructions stored in memory 730 and/or storage component 740 may cause processor 720 to perform one or more processes described herein.

Additionally, or alternatively, hardwired circuitry may be used in place of or in combination with software instructions to perform one or more processes described herein. Thus, implementations described herein are not limited to any specific combination of hardware circuitry and software.

The number and arrangement of components shown in FIG. 7 are provided as an example. In practice, device 700 may include additional components, fewer components, different components, or differently arranged components than those shown in FIG. 7. Additionally, or alternatively, a set of components (e.g., one or more components) of device 700 may perform one or more functions described as being performed by another set of components of device 700.

In embodiments, any one of the operations or processes of FIGS. 1-5 may be implemented by or using any one of the elements illustrated in FIGS. 6 and 7. It is understood that other embodiments are not limited thereto, and may be implemented in a variety of different architectures (e.g., bare metal architecture, any cloud-based architecture or deployment architecture such as Kubernetes, Docker, OpenStack, etc.).

The foregoing disclosure provides illustration and description, but is not intended to be exhaustive or to limit the implementations to the precise form disclosed. Modifications and variations are possible in light of the above disclosure or may be acquired from practice of the implementations.

Some embodiments may relate to a system, a method, and/or a computer readable medium at any possible technical detail level of integration. Further, one or more of the above components described above may be implemented as instructions stored on a computer readable medium and executable by at least one processor (and/or may include at least one processor). The computer readable medium may include a computer-readable non-transitory storage medium (or media) having computer readable program instructions thereon for causing a processor to carry out operations.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program code/instructions for carrying out operations may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects or operations.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer readable media according to various embodiments. In this regard, each block in the flowchart or block diagrams may represent a microservice(s), module, segment, or portion of instructions, which comprises one or more executable instructions for implementing the specified logical function(s). The method, computer system, and computer readable medium may include additional blocks, fewer blocks, different blocks, or differently arranged blocks than those depicted in the Figures. In some alternative implementations, the functions noted in the blocks may occur out of the order noted in the Figures. For example, two blocks shown in succession may, in fact, be executed concurrently or substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

It will be apparent that systems and/or methods, described herein, may be implemented in different forms of hardware, firmware, or a combination of hardware and software. The actual specialized control hardware or software code used to implement these systems and/or methods is not limiting of the implementations. Thus, the operation and behavior of the systems and/or methods were described herein without reference to specific software code—it being understood that software and hardware may be designed to implement the systems and/or methods based on the description herein.

What is claimed is:

1. A method of mitigating interference in a 5^{th} generation (5G) new radio (NR) environment, the method comprising:
determining a cumulative interference level margin corresponding to at least one satellite ground station and at least one base station;
determining whether the cumulative interference level margin is less than or equal to a maximum allowed interference margin for the at least one satellite ground station;
based on determining that the cumulative interference level margin is less than or equal to the maximum allowed interference margin, determining at least one of:
an optimal equivalent isotopically radiated power (EIRP) for the at least one base station; and
an optimal tilt for the at least one base station; and
configuring the at least one base station based on at least one of the optimal EIRP and the optimal tilt configuration.

2. The method of claim 1, wherein the cumulative interference level margin comprises a difference between the maximum allowed interference margin for the at least one satellite ground station and a cumulative interference of the at least one base station.

3. The method of claim 1, further comprising, prior to determining the cumulative interference level margin:
determining whether a number of satellite ground stations within a sector is greater than or equal to 1; and
based on determining that the number of satellite ground stations within the sector is greater than or equal to 1, identifying that the sector is an interference source,
wherein the sector corresponds to a coverage area of the at least one base station.

4. The method of claim 3, further comprising, based on identifying that the sector is an interference source, setting an EIRP of the sector to a predetermined minimum EIRP value.

5. The method of claim 3, further comprising, based on determining that the number of satellite ground stations is less than 1, setting an EIRP of the sector to a predetermined maximum EIRP value.

6. The method of claim 1, wherein determining the optimal EIRP for the at least one base station comprises:
obtaining a currently configured EIRP of the at least one base station;
obtaining a maximum EIRP of the at least one base station; and
based on the currently configured EIRP of the at least one base station being less than or equal to the maximum EIRP of the at least one base station, determining to increase the currently configured EIRP by a predetermined EIRP step value.

7. The method of claim 1, wherein determining the optimal tilt for the at least one base station comprises:
obtaining a current tilt of the at least one base station;
obtaining a maximum tilt of the at least one base station, and
based on the current tilt of the at least one base station being less than or equal to the maximum tilt of the at least one base station, determining to increase the current tilt of the at least one base station by a predetermined tilt step value.

8. The method of claim 7, wherein configuring the at least one base station comprises increasing the current tilt of the at least one base station, and
wherein the method further comprises:
obtaining a current NR reference signal received power (RSRP) of the at least one base station; and
based on the current NR RSRP of the at least one base station being greater than or equal to an allowed RSRP, reverting the increase of the current tilt of the at least one base station.

9. The method of claim 1, wherein the at least one base station comprises a first base station producing a first sector corresponding to a first coverage area of the first base station; and
wherein determining the optimal EIRP for the at least one base station comprises:
determining whether the first base station is a non-critical base station; and
based on determining that the first base station is a non-critical base station, determining to reduce a current EIRP of the first base station by a first predetermined EIRP step value.

10. The method of claim 9, wherein the at least one base station comprises a second base station producing a second sector corresponding to a second coverage area of the second base station; and
wherein determining the optimal EIRP for the at least one base station comprises:
determining whether the second base station is a critical base station; and
based on determining that the second base station is a critical base station, determining to increase a current EIRP of the second base station by a second predetermined step value.

11. A system for mitigating interference in a 5^{th} generation (5G) new radio (NR) environment, the system comprising:
at least one memory storing instructions; and
at least one processor configured to execute the instructions to:
determine a cumulative interference level margin corresponding to at least one satellite ground station and at least one base station;
determine whether the cumulative interference level margin is less than or equal to a maximum allowed interference margin for the at least one satellite ground station;
based on determining that the cumulative interference level margin is less than or equal to the maximum allowed interference margin, determine at least one of:
an optimal equivalent isotopically radiated power (EIRP) for the at least one base station; and
an optimal tilt for the at least one base station; and
configure the at least one base station based on at least one of the optimal EIRP and the optimal tilt configuration.

12. The system of claim 11, wherein the cumulative interference level margin comprises a difference between the maximum allowed interference margin for the at least one satellite ground station and a cumulative interference of at least one base station.

13. The system of claim 11, wherein the at least one processor is further configured to execute the instructions to, prior to determining the cumulative interference level margin:
determine whether a number of satellite ground stations within a sector is greater than or equal to 1; and
based on determining that the number of satellite ground stations within the sector is greater than or equal to 1, identify that the sector is an interference source,
wherein the sector corresponds to a coverage area of the at least one base station.

14. The system of claim 13, wherein the at least one processor is further configured to execute the instructions to, based on identifying that the sector is an interference source, set an EIRP of the sector to a predetermined minimum EIRP value.

15. The system of claim 13, wherein the at least one processor is further configured to execute the instructions to, based on determining that the number of satellite ground stations is less than 1, set an EIRP of the sector to a predetermined maximum EIRP value.

16. The system of claim 11, wherein the at least one processor is further configured to execute the instructions to determining the optimal EIRP for the at least one base station by:
obtaining a currently configured EIRP of the at least one base station;
obtaining a maximum EIRP of the at least one base station; and
based on the currently configured EIRP of the at least one base station being less than or equal to the maximum EIRP of the at least one base station, determining to increase the currently configured EIRP by a predetermined EIRP step value.

17. The system of claim 11, wherein the at least one processor is further configured to execute the instructions to determine the optimal tilt for the at least one base station by:
obtaining a current tilt of the at least one base station;
obtaining a maximum tilt of the at least one base station, and
based on the current tilt of the at least one base station being less than or equal to the maximum tilt of the at least one base station, determining to increase the current tilt of the at least one base station by a predetermined tilt step value.

18. The system of claim 17, wherein the at least one processor is further configured to execute the instructions to configure the at least one base station by increasing the current tilt of the at least one base station, and
wherein the at least one processor is further configured to execute the instructions to:
obtain a current NR reference signal received power (RSRP) of the at least one base station; and
based on the current NR RSRP of the at least one base station being greater than or equal to an allowed RSRP, revert the increase of the current tilt of the at least one base station.

19. The system of claim 11, wherein the at least one base station comprises:
a first base station producing a first sector corresponding to a first coverage area of the first base station; and
a second base station producing a second sector corresponding to a second coverage area of the second base station,
wherein the at least one processor is further configured to execute the instructions to determine the optimal EIRP for the at least one base station by:
determining whether the first base station is a non-critical base station;
based on determining that the first base station is a non-critical base station, determining to reduce a current EIRP of the first base station by a first predetermined EIRP step value,
determining whether the second base station is a critical base station; and
based on determining that the second base station is a critical base station, determining to increase a current EIRP of the second base station by a second predetermined step value.

20. A non-transitory computer-readable storage medium storing instructions that, when executed by at least one processor, cause the at least one processor to:
determine a cumulative interference level margin corresponding to at least one satellite ground station and at least one base station;
determine whether the cumulative interference level margin is less than or equal to a maximum allowed interference margin for the at least one satellite ground station;
based on determining that the cumulative interference level margin is less than or equal to the maximum allowed interference margin, determine at least one of:
an optimal equivalent isotopically radiated power (EIRP) for the at least one base station; and
an optimal tilt for the at least one base station; and
configure the at least one base station based on at least one of the optimal EIRP and the optimal tilt configuration.
